(19) United States
(12) Patent Application Publication
(10) Pub. No.: US 2013/0257214 A1
(43) Pub. Date: Oct. 3, 2013

(54) GLASS FIBER COMPOSITE MATERIAL FOR ELECTRICAL INSULATION

(71) Applicants: Joel A. Kern, Wytheville, VA (US); Thomas A. Hartmann, Wytheville, VA (US); Samuel S. Outten, Wytheville, VA (US)

(72) Inventors: Joel A. Kern, Wytheville, VA (US); Thomas A. Hartmann, Wytheville, VA (US); Samuel S. Outten, Wytheville, VA (US)

(73) Assignee: ABB TECHNOLOGY AG, Zurich (CH)

(21) Appl. No.: 13/435,603

(22) Filed: Mar. 30, 2012

(51) Int. Cl. H02K 3/34; H01F 27/28; H01B 17/00

(52) U.S. Cl. 310/179; 174/137 R; 336/220

(57) ABSTRACT

A composite electrical insulation material is comprised of first, second and third layers. The first and third layers are glass fiber mat and the second layer is a thin film material. The first and third layers are bonded to the second layer using a thin resin solution. The insulation is used in electrical machines such as transformers, generators, and motors. The insulation serves as a high/low barrier, high voltage conductor wrap, and low voltage sheet insulation in transformers. In generators and motors, the insulation serves as wrap for conductor windings and wedge insulation for stator and rotor assemblies.

### FIELD OF INVENTION

The present application is directed to a glass fiber composite material for use as insulation in electrical machines.

### BACKGROUND

Insulation is used in electrical applications such as transformers, motors and generators to provide withstand to high AC, DC, or transient voltages (such as impulse voltage) at high operating temperatures. Insulation materials such as inorganic clays, aramid papers, polyimide films, and polyester films, as well as composites of those materials have been used as insulation in transformers, electric motors and generators.

### SUMMARY

A composite insulation material for an electrical machine has first and third layers formed from a glass fiber mat and a second layer of a thin film bonded to said first and third layers. At least one of the first and third layers is in contact with a conductor of the electrical machine.

A transformer utilizing the composite insulation material has a ferromagnetic core having at least one core leg and a coil assembly mounted to the at least one core leg. Further, the coil assembly is formed of a low voltage coil winding, a high voltage coil winding, and a high/low barrier located between the high and low voltage coil windings. The high/low barrier is formed from a composite material having at least three layers. The first and third layers are a glass fiber and the second layer is a thin film material. The first layer is in contact with the low voltage coil winding and the third layer is in contact with the high voltage coil winding.

A transformer coil winding has composite insulation sandwiched between successive layers of sheet conductor. The composite insulation has first and third layers formed of a glass fiber and in contact with said successive conductor layers, and a second layer formed of a thin film between the first and third layers.

An electrical machine such as a transformer, generator or motor, has at least one winding formed of a conductor wire. The conductor wire is encompassed by composite insulation. The composite insulation is comprised of a first and third layer of glass fiber and a second layer comprised of a thin film. The composite insulation surrounds an entire outside surface of said conductor wire.

### BRIEF DESCRIPTION OF THE DRAWINGS

In the accompanying drawings, structural embodiments are illustrated that, together with the detailed description provided below, describe exemplary embodiments of a composite insulation material for electrical applications. One of ordinary skill in the art will appreciate that a component may be designed as multiple components or that multiple components may be designed as a single component.

Further, in the accompanying drawings and description that follow, like parts are indicated throughout the drawings and written description with the same reference numerals, respectively. The figures are not drawn to scale and the proportions of certain parts have been exaggerated for convenience of illustration.

FIG. 1 shows a perspective view of a section of a sheet of composite insulation embodied in accordance with the present invention;

FIG. 2 shows an exemplary coil assembly having an insulating high/low barrier formed from the sheet of composite insulation; and

FIG. 3 is an exploded view of stator and rotor assemblies in an exemplary motor, showing the utilization of the composite insulation in an exemplary embodiment of the present invention.

### DETAILED DESCRIPTION

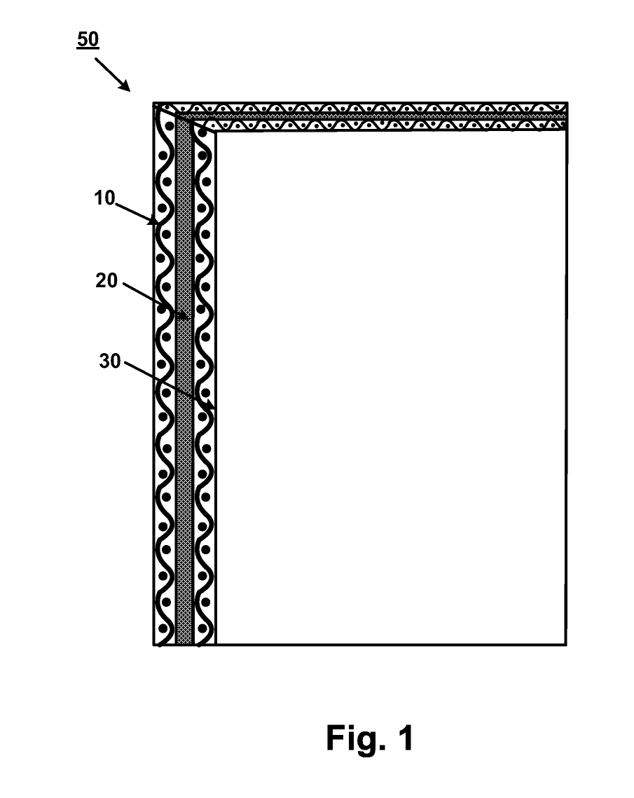

With reference to FIG. 1, a multi-layer sheet of composite electrical insulation material 50 (herein after composite insulation 50) is depicted. Although the composite insulation 50 is depicted as having three layers, the composite insulation 50 may be embodied as two, three, four or more layers, depending on the application.

An embodiment of the composite insulation 50 having two layers is formed of a first layer 10 of a glass fiber mat and a second layer 20 of polyethylene naphthalate or another material suitable for the application as described below. An embodiment of the composite insulation 50 having three layers is formed from first and third layers 10, 30 of a glass fiber material and a second layer 20 of polyethylene napthalate film sandwiched between said first and third layers 10, 30. Alternatively, the composite insulation 50 may be embodied as four layers, having an outside layer of glass fiber material on opposing sides of a double layer of polyethylene napththalate.

The composite insulation 50 has applications in various electrical devices and machines including but not limited to motors, transformers, and generators. The composite insulation 50 was developed to protect electrical machines from thermal and dielectric stresses in systems having ratings of from about 0 Volts to about 1,000 Volts such as general purpose transformers and induction motors as well as dry-type distribution transformers having ratings of from about 1,000 Volts to about 34,500 Volts.

A preferred embodiment of the composite insulation 50 is comprised of at least three layers. The first and third layers 10, 30 are comprised of a sheet of glass fiber mat or other suitable glass fiber material. The thickness of the first and third layers 10, 30 is from about 0.025 mm to about 0.26 mm. An example of a glass fiber mat that is suitable for the application is Advantex® E-CR glass, available from Owens Corning Composite Materials of Toledo, Ohio.

A second layer 20 of the composite insulation 50 is comprised of a film sheet of polyethylene naphthalate or another suitable material for the application. An example of a film sheet that is suitable for the second layer is Teonex® available from Teijin DuPont Films of Tokyo, Japan. Other materials suitable for the second layer 20 include but are not limited to polyethylene terephthalate, aramid paper, aramid fiber, dacron, polyetheretherketone, or a polyimide, such as poly(meta-phenyleneisophthalamide). The thickness of the second layer 20 is from about 0.025 mm to about 0.51 mm.

The second layer 20, when embodied as a polyethylene naphthalate film, satisfies the requirements of a 180(H) class material in accordance with Underwriters Laboratories, Inc. (UL) Standards. However, the addition of the first and third layers 10, 30 of glass fiber act as a thermal shield, allowing the composite insulation 50 to operate at a higher UL thermal class of 200(N) in accordance with Table 4.2 of the UL 1446 standard.

The first and third layers 10, 30 are bonded to the second layer 20 using a thin resin solution such as a polyesterimide. The first and third layers 10, 30 are saturated with the thin resin solution and pressed against opposing sides of the second layer 20, respectively. The desired dry thickness of the thin resin solution after bonding is complete is from about 0.012 mm to about 0.26 mm, however, the thickness may vary outside of the aforementioned range depending on the application.

The first and third layers 10, 30 are adhered to the second layer 20 using a dielectric insulation lamination machine under high pressure and temperature to form a sheet of composite insulation 50. The high temperature and pressure conditions that are present during the lamination process allow the thin resin solution to cure and bind the first and third layers 10, 30 to the second layer 20.

The resulting composite insulation 50 has sufficient flexibility to allow formation into a roll for storage or transport. The composite insulation 50 is unrolled and cut to a predetermined size for the application following the lamination process. Alternatively, the first, second, and third layers 10, 20, 30, are each pre-cut to a predetermined length prior to entering the lamination machine, so that a sheet of composite insulation 50 having the desired size is produced following lamination.

Further, the composite insulation 50 has application in transformers wherein the thermal and dielectric withstand of a 220(R) insulation system is required. The glass fibers of the first and third layers 10, 30, as well as the second layer 20 of thin film may be provided in a greater thickness than mentioned previously to achieve a dielectric strength at a higher end of a transformer operating range, such as a temperature of 200 degrees Celsius.

The open wound or vacuum cast transformer in which the composite insulation 50 is utilized may be single phase or poly-phase (e.g., three phases). The transformer has a core formed of thin, stacked laminations of magnetically permeable material, such as grain-oriented silicon steel or amorphous metal. The laminations are typically arranged in stacks such that the core has at least one leg disposed vertically between a pair of yokes disposed horizontally. A coil assembly 80 is mounted to each core leg, and comprises low and high voltage coil windings 66, 24.

The composite insulation 50 has several applications in open wound transformers. An open wound transformer has coil windings that are coated, impregnated or encapsulated with a varnish by dipping or using a vacuum and pressure application process. The composite insulation 50 serves as the high/low insulating barrier 60 between a low voltage coil winding 66 and a high voltage coil winding 24, layer insulation in an open wound transformer utilizing wide sheet conductor in the low voltage coil winding 24 and/or insulation wrap for a high voltage conductor wire in an open wound transformer.

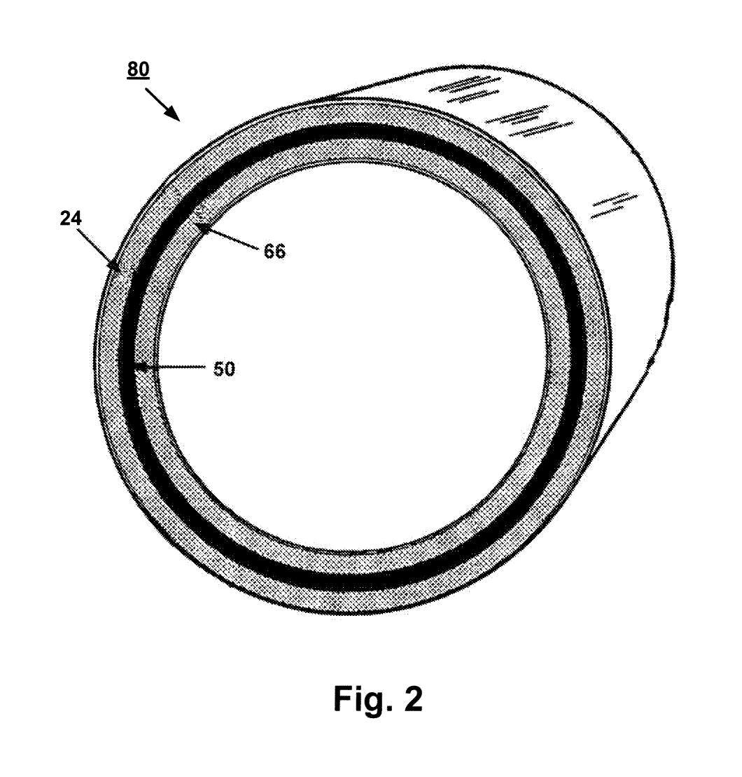

Referring now to FIG. 2, the composite insulation 50 is embodied as a high/low barrier, between the high and low voltage coil windings 24, 66 in a transformer coil assembly 80. The composite insulation 50 is embodied as a sheet cut to a predetermined length and formed around the low voltage coil winding 66. The width of the sheet used to form the high/low barrier is approximately 1.22 meters although other widths may be used depending on the application. The thickness of the composite insulation 50 is dependent on the rating of the transformer.

The sheet of composite insulation 50 used to form the high/low barrier may be secured together at first and second ends using a glass tape or other dielectric tape. Alternatively, the sheet of composite insulation 50 may be wrapped around the low voltage winding in one or more successive layers of composite insulation 50 before the insulation is secured by dielectric tape or another means. The high voltage coil winding 24 is then installed over the high/low barrier, so that a first layer 10 of the high/low barrier is in contact with the low voltage coil winding 66 and a third layer 30 of the high/low barrier is in contact with the high voltage coil winding 24.

In an embodiment having a high voltage coil winding 24 formed from a disc wound high voltage conductor, the high/low barrier may include a comb structure (not shown). The comb structure is formed from the composite insulation 50 into the desired shape. If comb structures are provided, the high voltage conductor wire (wrapped in composite insulation 50) is wound through a circumferentially-arranged series of notches or gaps formed by teeth (not shown) of the comb structures, wherein each gap is formed between a pair of adjacent teeth in a comb structure. Further, spacers formed from the composite insulation 50 may be placed within the gaps formed by the comb structures.

The composite insulation 50 has application in a wrap for high voltage rectangular conductor wire made of copper or aluminum in an open wound transformer. An open wound transformer has coil windings that are coated, impregnated or encapsulated with a varnish by dipping or using a vacuuming and pressure application process. In that same embodiment, the thickness of the composite insulation 50 surrounding the rectangular conductor wire is from about 0.038 mm to about 0.077 mm. The composite insulation 50 is compatible as a wrap for narrow sheet, strip or foil conductors that are disc-wound or wound by other methods known in the art and suitable for the application. The composite insulation 50 encompasses an entire outside surface of the high voltage rectangular conductor wire.

The composite insulation 50 has application to open wound and vacuum cast transformers as wide sheet composite insulation 50 in the low voltage coil winding 66. The width of the sheet used to form the wide sheet composite insulation 50 is approximately 1.22 meters although other widths may be used depending on the application.

The composite insulation 50 is used to shield successive adjacent layers of low voltage wide sheet conductor from one another. In that same embodiment, the composite insulation 50 layers are alternated with or sandwiched between successive layers of sheet conductor material such as copper or aluminum conductor sheeting as the coil is wound. The low voltage coil 66 may be wound on a mandrel and/or standard coil forming machine. As the low voltage coil 66 is being wound, ducts formed from the composite insulation 50 may be placed between successive layers of sheet conductor material, in the manner described in U.S. Pat. No. 7,023,312 to Lanoue et al., the entire contents of which is hereby incorporated by reference in its entirety. It should be understood that when the composite insulation 50 is embodied as ducts, combs, or spacers, the thickness of the composite insulation 50 will vary according to the application.

The composite insulation 50 is also used in vacuum cast high voltage coils as narrow sheet insulation. Vacuum cast transformers have coil windings that are cast with a resin in a mold under a vacuum. In that same embodiment, the composite insulation 50 is compatible with narrow sheet conductors that require a thermal withstand of at least 220 degrees Celsius during operation of the transformer. The composite insulation 50 used to wrap the narrow sheet conductor has a thickness of from about 0.05 mm to about 0.09 mm. The narrow sheet conductor may be wound in a foil or disc fashion.

The composite insulation 50 has various applications in motors and generators, including but not limited to wrap or layer insulation for rotor and/or stator windings, rotor slot insulation, and corner insulation. The composite insulation 50 may also be provided in strips, stator wedges, or other embodiments to damp undesired motor vibrations. An example of a motor in which the composite insulation 50 has application is a General Purpose AC Motor, Catalog number M3353, available from Baldor Electric Company of Fort Smith, Ark.

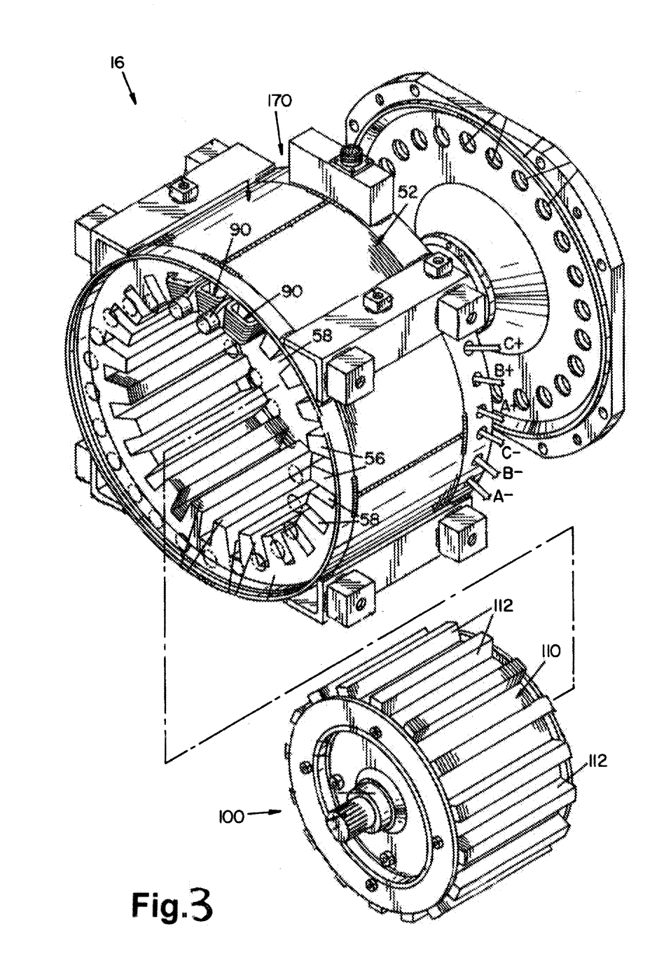

Referring now to FIG. 3, an exemplary motor 16 that may utilize the composite insulation 50 is shown. The motor 16 has a stator assembly 170 and a rotor assembly 100. The stator assembly 170 has conductor windings 90 that are wrapped in composite insulation 50. In one embodiment, the wrap for the conductor windings 90 is from about 0.038 mm to about 0.077 mm thick. The composite insulation 50 may be utilized in the stator assembly 170 wherein the composite insulation 50 is embodied as a wedge placed in gaps 58 between stator poles 56 and adjacent conductor windings 90.

Alternatively, the composite insulation 50 may be utilized in the rotor assembly 100 between rotor poles 112 and adjacent conductor windings 90 as a wedge. Another use for the composite insulation 50 is between motor 16 housing surfaces 52, 110 and the stator assembly 170 and/or rotor assembly 100, respectively.

While the present application illustrates various embodiments of composite electrical insulation 50, and while these embodiments have been described in some detail, it is not the intention of the applicant to restrict or in any way limit the scope of the appended claims to such detail. Additional advantages and modifications will readily appear to those skilled in the art. Therefore, the invention, in its broader aspects, is not limited to the specific details, the representative embodiments, and illustrative examples shown and described. Accordingly, departures may be made from such details without departing from the spirit or scope of the applicant's general inventive concept.

What is claimed is:

1. A composite insulation material for an electrical machine selected from the group consisting of a transformer, generator and motor, said composite insulation comprised of first and third layers of glass fiber mat, a second layer of a thin film bonded to said first and third layers, at least one of said first and third layers in contact with a conductor of said electrical machine.

2. The composite insulation of claim 1 wherein said second layer is selected from the group consisting of polyethylene naphthalate film, polyethylene terephthalate film, aramid paper, aramid fiber, polyester fiber, polyester film, polyetheretherketone, polyimide film, and poly(meta-phenyleneisophthalamide).

3. The composite insulation of claim 1 wherein said second layer is bonded to said first and third layers, respectively, by a polyesterimide solution.

4. A transformer comprising:
a ferromagnetic core having at least one core leg; and
a coil assembly mounted to said at least one core leg, said coil assembly comprising:
a low voltage coil winding,
a high voltage coil winding, and
a high/low barrier disposed between said high and low voltage coil windings, said high/low barrier formed from a composite material having at least three layers, said composite material comprised of first and third layers of glass fiber and a second layer of a thin film material, said first layer in contact with said low voltage coil winding and said third layer in contact with said high voltage coil winding.

5. The transformer of claim 4 wherein said second layer is selected from the group consisting of polyethylene naphthalate film, polyethylene terephthalate film, aramid paper, aramid fiber, polyester fiber, polyester film, polyetheretherketone, polyimide film, and poly(meta-phenyleneisophthalamide).

6. The transformer of claim 4 wherein said second layer is bonded to said first and third layers using a polyesterimide solution.

7. A transformer coil winding, having composite insulation sandwiched between successive layers of sheet conductor, said composite insulation having first, second, and third layers, said first and third layers formed of a glass fiber and in contact with said successive conductor layers, and said second layer formed of a thin film and disposed between said first and third layer.

8. The composite insulation of claim 7 wherein said second layer is selected from the group consisting of polyethylene naphthalate film, polyethylene terephthalate film, aramid paper, aramid fiber, polyester fiber, polyester film, polyetheretherketone, polyimide film, and poly(meta-phenyleneisophthalamide).

9. An electrical machine having at least one winding formed of a conductor wire, said electrical machine selected from the group consisting of a transformer, generator and motor, said conductor wire encompassed by composite insulation, said composite insulation comprised of a first and third layer of glass fiber and a second layer comprised of a thin film, said composite insulation surrounding an entire outside surface of said conductor wire.

10. The electrical machine of claim 9 wherein said thin film is selected from the group consisting of polyethylene naphthalate film, polyethylene terephthalate film, aramid paper, aramid fiber, polyester fiber, polyester film, polyetheretherketone, polyimide film, or poly(meta-phenyleneisophthalamide).
